(19) United States
(12) Patent Application Publication
(10) Pub. No.: US 2008/0234530 A1
(43) Pub. Date: Sep. 25, 2008

(54) Atmospheric Pressure Plasma Treatment of Gaseous Effluents

(76) Inventors: Yassine Kabouzi, Fremont, CA (US); Michel Moisan, Outremont (CA); Jean-Christophe Rostaing, Versailles (FR); Daniel Guerin, Chelles (FR); Herve Dulphy, Jarrie (FR); Pascal Moine, Brie Et Angonnes (FR); Valere Laurent, Villard Bonnot (FR); Bruno Depert, Corenc (FR)

Correspondence Address: AIR LIQUIDE;Intellectual Property, 2700 POST OAK BOULEVARD, SUITE 1800, HOUSTON, TX, 77056, US

(21) Appl. No.: 11/571,652

(22) PCT Filed: Jul. 8, 2005
(86) PCT No.: PCT/FR2005/050555

§ 371 Date: Dec. 4, 2007

(30) Foreign Application Priority Data
Jul. 13, 2004 (FR) 0451527
Jul. 6, 2005 (FR) 0552063

(51) Int. Cl. A62D 3/17; B01J 19/08

(52) U.S. Cl. 588/306; 422/186.01

(57) ABSTRACT

The invention relates to a method for the conversion of a gas or gas mixture and, in particular, a fluorinated gaseous effluent. According to the invention, at least one bond between two atoms of at least one molecule of the gas or gas mixture is broken under the influence of an electric and/or magnetic field to which the gas or gas mixture is subjected. The gas or gas mixture stream is injected through the electric and/or magnetic field in a non-rectilinear manner in order to increase the distance travelled by the gas molecules through the field and, in this way, increase the effectiveness of the conversion of the gas or gas mixture molecules.

The present invention relates to a method for converting a first gas or gas mixture containing at least some molecules having at least one bond between two atoms constituting said molecules, into a second gas or gas mixture possibly containing liquid and/or solid products derived from this conversion, wherein at least one bond between two atoms of said molecules is ruptured under the action of an electric and/or magnetic field to which said first gas or gas mixture is subjected.

A method of this type applied to the destruction of effluents is known in particular from U.S. Pat. No. 5,965,786.

Plasmas are in particular applied to the removal of pollution from discharges emitted by processes for the deposition and etching of thin layers for the production of semiconductors. These effluents (fluorinated gases, corrosive halogenated compounds, gaseous hydrides, organometallic precursors etc.) are present in the exhaust from primary vacuum pumps at relatively high concentrations in a flow of 15 to 60 liters of nitrogen for each pump. In order to convert the greater part of these large quantities of harmful molecules, microwave discharges at atmospheric pressure are preferable to others by reason of their high electron density (10¹² to 10¹⁵ cm⁻³) enabling a large number of dissociative inelastic collisions to be induced.

One characteristic of atmospheric microwave plasmas is the relatively high mean energy taken up by heavy particles (neutral particles and ions). The temperature of the gas may indeed reach 3000 to 7000 K in the zone of the axis of the dielectric chamber containing the discharge. The wall of this chamber (for example a dielectric tube) should remain at the lowest temperature compatible with its physical integrity. It is also preferably cooled by the circulation of a heat-carrying dielectric fluid in contact with it. A radial temperature gradient therefore exists decreasing from the axis to the periphery. When the temperature falls, the density of the gas increases, ionization is less probable and recombination of charged particles is promoted. Thus, the electron density decreases at the same time as the temperature decreases from the axis to the periphery. Visually, it is found that the luminous intensity of the discharge becomes attenuated as it is further away from the axis. In some cases, the electron density becomes very low for an axial position less than the radius of the tube and the discharge no longer fills the cross section of the latter. It is then said that the discharge has contracted.

The form of this radial distribution of the electron density toward the periphery depends in particular on the operational parameters of the plasma: the nature and concentrations of the various pollutant gases in nitrogen, the total flow rate and the microwave power. It also depends on previously fixed parameters such as the internal diameter of the discharge tube and the nature of the material of which it is made (via in particular thermal conductivity).

It can be understood that the radial distribution of electron density and gas temperature influences the thermal exchange relationship between the gaseous medium and the wall of the tube and consequently the reliability of the latter. It has been found that some gases such as helium and hydrogen, from nitrogen contents of the order of one percent, have the effect of promoting the radial expansion of the discharge and therefore of increasing the gas temperature in the vicinity of the wall of the tube. In this way, aging of the latter by a heat effect is accentuated.

It has also been found that other gases have the reverse effect and promote radial contraction of the discharge. In this case, it is generally observed that the plasma does not remain constantly centered on the axis, but moves randomly within the cross section of the tube. When the plasma is decentered and approaches the wall of the tube, this is temporarily exposed to a very high gas temperature as well as the action of electrons out of thermodynamic equilibrium, with an even higher energy. This limiting case is that where the plasma is present as one or more very dense filaments which, if they come into contact with the wall for a sufficiently long period, produce extreme localized stresses on the latter. There is therefore a risk of rupturing the wall by thermomechanical overload, point erosion of the wall of the tube by high energy fluorinated species and also carbonization of the dielectric cooling fluid on the outer surface of the tube opposite the point of contact of the plasma on the wall.

A first solution for this type of problem consists of using a tube made of a very high performance material such as aluminum nitride, with which this degradation phenomenon becomes extremely rare, without it being impossible to foresee its occurrence. In particular, the parameters governing the contraction phenomenon and filamentation are generally set by the characteristics of recipes of the user's methods which can make use of various halogenated gases, a plasmogenic gas such as argon and various additives such as helium, hydrogen or other chemical additives, or even heavy rare gases, all in very variable proportions that are generally unknown.

As moreover the contact phenomenon between the plasma and the wall is itself totally random, it is therefore very difficult to guard against these phenomena which induce a risk of harming the operation and therefore the safety of the installation.

In addition, the existence of a radial density gradient of the plasma also plays a large part in limiting the performance of systems for the destruction of effluents. Indeed, the peripheral zone of the chamber is colder and depleted in electrons. Consequently dissociation of pollutant molecules is less probable in this peripheral zone than in the central zone and their reformation from their fragments is promoted (on account of the fact that relatively high absolute concentrations exist). A pollutant gas molecule passing through the chamber while remaining in this low energy peripheral zone has a much lower probability of being dissociated than if it passed through close to the axis. It can be envisaged that said molecule during its passage migrates towards the hotter central zone by diffusion, convection or turbulence. However, in nitrogen, the plasma column is relatively short and the speed of passage is relatively high if account is taken of the total flow of nitrogen leaving the primary pumps, so that these processes for the exchange of material have scarcely the time to be completed.

The invention also relates to generators of gases such as fluorine F₂ obtained by cracking of a molecule such as NF₃ in a plasma. Such a method and the associated generator are described in international patent PCT/FR05/01652 filed on 29 Jun. 2005 in the name of the Applicant and of which the text is incorporated in the present application by way of reference.

The invention makes it possible in particular to respond to problems presented by microwave plasmas in a chamber, particularly in a tube:
on the one hand, by opposing variations in diameter and random axial off-centering of the plasma in order to improve the endurance and reliability of the discharge tube,
on the other hand, by forcing the pollutant gas molecules to follow an appreciably longer path in the dense zones of the plasma in order better to utilize the excess active species available on average in the system, as well as to increase the conversion efficiency relative to the power injected.

The method according to the invention is characterized in that the stream of gas or gas mixture is injected through the electric and/or magnetic field in a non-linear manner in order to increase the distance traveled by the gas molecules through said field and therefore to increase the effectiveness of the destruction of molecules of the gas or gas mixture.

Preferably, the gas or gas mixture is injected into the field with an amount of tangential movement of the gas or gas mixture greater than the amount of axial movement of said gas or gas mixture and in addition, the amount of tangential movement is very much greater than the amount of axial movement.

According to one feature of the invention, at least part of the gas or gas mixture is injected with a tangential velocity component into a cavity, preferably a tubular cavity, before being subjected to the action of the electric and/or magnetic field.

Preferably, the gas or gas mixture is injected by means of a plurality of injections comprising a tangential component.

According to a preferred variant, the tangential injections are regularly distributed over the circumference.

Various variant embodiments are possible, in particular:

injections or gas mixtures are all situated in the same plane;

or

the injections are situated in different planes.

Injections that are situated in the same plane are regularly distributed in this plane.

According to one variant embodiment:

at least one plane only has one injection; and/or at least one plane has two injections at 180°; and/or at least one plane has three injections at 120°; and/or at least one plane has four injections at 90°.

In general, the injection plane or planes is/are perpendicular to the axis of the tube or of the cavity subjected to the field. However, according to one variant of the invention, at least one of the injections is made through an orifice oriented so as to give a velocity component of the injected gases that is parallel to the desired direction of flow for the gases toward or into the cavity. Thus, in the case of a gas injection into a cavity, in particular a tubular cavity, which is generally arranged vertically during its use, the gas flowing downward, it is preferable in some cases not to make this injection horizontally, but in a direction inclined downward with respect to the vertical axis of the cavity, at an angle that can vary between 0° and 90°, preferably between 20° and 70°, more preferentially at about 45°.

The operating conditions of plasma devices situated at the outlet from pumps of etching and deposition reactors (at atmospheric pressure or close to atmospheric pressure) should, in general, make it possible to absorb a total flow at the inlet greater than 80 liters per minute (slm) when the exhausts from several etching chambers are connected simultaneously to the depollution unit and operate simultaneously. The gas then consists essentially of nitrogen. In order to obtain good conversion efficiency of the most stable molecules, such as PFCs, the necessary total power should generally be greater than 3 kW and cooling is provided of the outer wall of the cavity, particularly the discharge tube.

Implementation of the invention generally makes it possible to establish a system of hydrodynamic forces which tend to maintain the axial symmetry of the system and to prevent random disturbance, in particular of an electromagnetic or thermal nature, from displacing the plasma from the axial position.

Among the advantages of the invention will be noted:
a reduction in the mean temperature of the wall, making it possible in this way to space out further the preventive maintenance operations of the discharge tube,
maintenance of the plasma away from the wall of the cavity (the tube, for example) preventing localized rises in the temperature of this wall, that can reach temperatures of the order of 1000° C.

The flow of the fluid according to the invention makes it possible to extend considerably the path of the gas in the active zone by preferably giving the flow a helical movement (when a cavity with axial symmetry is used) and also by promoting exchanges of material by turbulence between zones of high and low plasma energy.

In practice, it is preferable, in particular when it is desired to maintain the helical movement, to comply with a certain number of constraints. Preferably:
the compactness of the device must first of all be preserved, without if possible adding any appreciable supplementary bulk to the device not involving the injection of gas according to the invention,
a limited pressure loss should also be preserved on the gas flow to be treated, imposed by the operational pressure of the exhaust from the primary pump in case of use for the destruction of effluents coming from a reactor for producing semiconductors.

In a general manner, gas injection will preferably be tangential and made by means of one or more channels provided in the flange connecting the pipes bringing in the stream of effluent gases upstream to the discharge tube.

In the case in particular of a helical movement of the gas, this propellant gas stream used to obtain such a movement can be reduced to the aforementioned gaseous effluents coming from the exhaust from the primary pump. In order to maintain such a movement in a stable manner, the amount of tangential movement of the gas should in general be preferably appreciably greater than its axial homologue. This involves providing tangential inlet channels for the gas in the region of the connection supplying the tube, each of which has a cross section substantially smaller than the diameter of the discharge tube. This adds an appreciable component to the pressure loss of the device, which should not reach a value such that the total excess pressure at the exhaust from the primary pump exceeds the permitted practical limit.

However, systems for treating effluents are generally used with a variable capacity, often permanently with one to four process reactors discharging at the same time. In order to maintain the helical movement, particularly while observing a maximum pressure loss, the diameter of the gas injection channels will be adapted to the flow treated.

In order to be adapted to variable flow rates over a wide range, it will be possible for example to use a supplementary auxiliary stream of propellant gas for launching the vortex, which will not necessarily be subjected to the constraint of a maximum excess pressure at the inlet. More precisely, operating a system for treating effluents by plasma, in particular by microwaves, generally requires the addition of one or more auxiliary reactive gases, for example air, oxygen, steam etc, provided for example in the form of compressed air. Also, very often, for reasons linked to the operation, this stream of air is increased beyond the simple value necessary for accomplishing chemical reactions for converting pollutants. This additional air stream may come from the distribution network of the factory producing semiconductors, at a pressure of several bar. It can thus be used perfectly well on small diameter orifices. Moreover, the additional dilution introduced is largely compensated for by the increase in the specific efficiency of the destruction of pollutants induced by the presence of the gas stream according to the invention, in particular the helical movement of these gases.

In concrete terms, the injection system can take several forms. The tangential channels can emerge at only one level or at several levels. The gas feed upstream to the injection channels (division of the stream) is provided, in a known manner, so as not to add any significant pressure loss.

When a dielectric tube is used, for example as described in patent U.S. Pat. No. 5,965,786, the maximum internal diameter of the tube is dictated by the electron density radial gradient phenomenon of the discharge. When the value of the internal diameter of the tube is increased, all things being in addition equal, it is found that the efficiency of the conversion of pollutants first of all increases on account of the increase in dwell time with that of the cross section. However, beyond a certain value, the efficiency falls on account of the fact that the cross section of the discharge fills a smaller and smaller fraction of the cross section of the tube and the radial extension of the peripheral cold zone increases. Thus an increasing proportion of the pollutant molecules is likely to pass through the tube in a region of low reaction activity, and the conversion yield of the device decreases.

By adding a helical movement to the gas, it is possible to use an internal diameter of the dielectric tube that is appreciably greater than that used without this movement of the gases, without a large drop in conversion efficiency. The use of a larger diameter tube enables larger flow rates to be treated while increasing the power provided to the plasma, without accentuating the thermal stress on the tube and without having a greater pressure loss.

The invention will be illustrated in the figures which show:

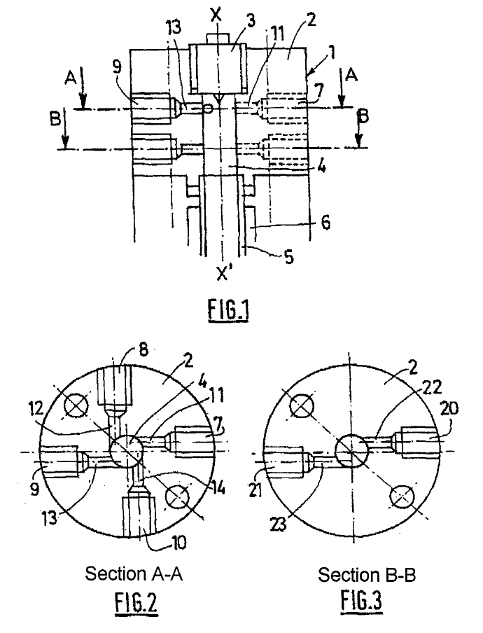

FIG. 1, a sectional view of the gas injection system according to the invention;

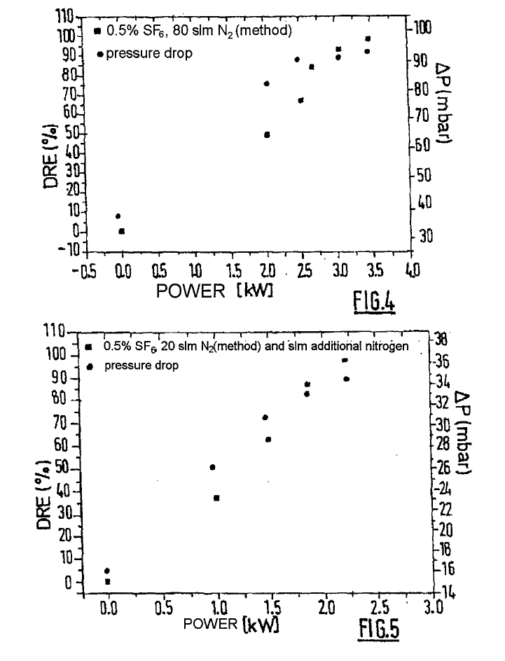

FIG. 2, a section along A of the device of FIG. 1;

FIG. 3, a section along B of the device of FIG. 1;

FIGS. 4 and 5, a view of different results of measurements,

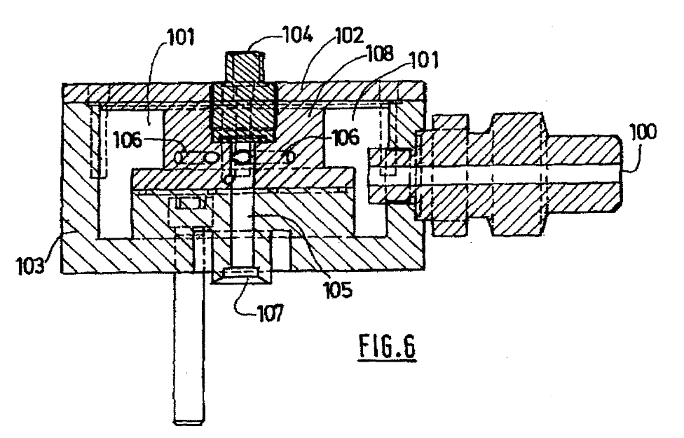

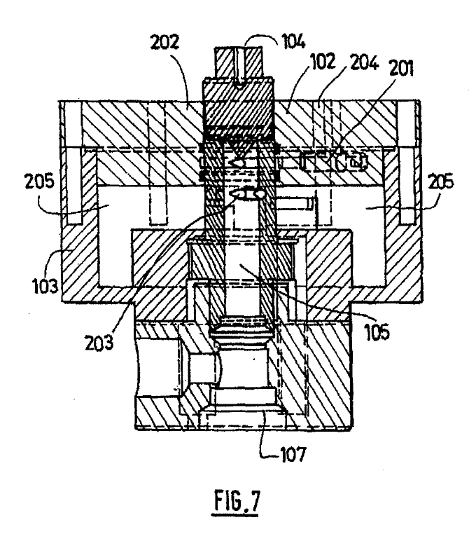

FIG. 6, a view in vertical section of a dynamic injection head with a single step;

FIG. 7, similarly in vertical section, a dynamic injection head with two stages.

In FIG. 1, the gas injection device 1 has been modified as compared with the device described in U.S. Pat. No. 5,965,786 in which there was for example only one tangential gas injection made in a lateral cylindrical opening having a diameter substantially equal to that of the dielectric tube 5 where the plasma is produced (by virtue of means not shown in the figure). If the vertically oriented axis X-A′ is considered (axis of the dielectric tube 5 and of the gas injection cavity 4), gas injections to be treated are made according to this example through the part 2 through four injection orifices 7, 8, 9 and 10 (FIGS. 1 and 2) situated in a plane perpendicular to X-X′. These orifices are extended respectively by the channels 11, 12, 13 and 14 respectively to rejoin the injection cavity for the gases 4. These four channels and orifices are oriented respectively at 90° according to this example. Looking at FIG. 2, this is a section along the orthogonal plane A-A through the part 2. The electrode 3 which enables the plasma to be ignited is situated above the injection cavity for the gases. A second set of orifices 20, 21 and gas injection channels 22, 23, positioned at 180° to each other respectively, are situated in the orthogonal plane B-B (see the section in FIG. 3). A gas is injected into these orifices, for example a gas under pressure (for example 2 to 10×10⁵ Pa), such as compressed air that is always available in a manufacturing plant. This pressurized gas will have a propelling effect so as to form the helical movement of the gas to be treated issuing from the four orifices in the plane A-A.

The process gas to be destroyed can also be injected into the plane B-B, but it is preferred to inject air, nitrogen and possibly an oxidizing gas promoting a reaction with the destroyed molecules under pressure, preferably between 1 and 10×10⁵ Pa. All injection orientations of the various gases are possible, in particular orientations which are not made in the plane perpendicular to the axis of the tube, but at an angle less than 90° (co-current) or greater than 90° (counter-current) etc.

The prior division of the total flow in order to feed the four channels 7, 8, 9 and 10 in the example in a uniformly distributed manner is usually carried out from an equalizing chamber (not shown) in which the gas streams are mixed and of which the conditions are made uniform, in which the main channel coming from the exhausts from the pumps emerges. This chamber divides four branch channels in a relatively symmetrical manner. As far as possible, the incoming flow and divided outgoing flows from this chamber should be parallel so as not to add pressure losses.

At a high flow rate (for example four gram chambers connected simultaneously), it is necessary at such a flow rate to use channels injecting an auxiliary stream of gas (plane B-B) in order to have a sufficient tangential impulse so as to maintain the helical movement of the gas. However, it is possible to inject, through these channels 22, 23, a minimal compressed flow serving to provide the necessary quantity of oxygen for carrying out chemical conversion reactions of perfluorinated molecules.

Destruction experiments have been carried out with a mixture of SF₆ diluted with nitrogen, at a representative concentration of 5000 parts per million by volume (ppmv). Oxygen was added as the auxiliary reactive gas at a rate of approximately 1.5 times the quantity by volume of SF₆ to be treated. FIG. 4 shows the progress of the rate of destruction of SF₆ as a function of the microwave power (net) provided to the plasma, as well as the total pressure loss between the inlet for gas into the equalizing chamber and the outlet for gases after they are cooled in a heat exchanger (not shown in the figure) serving to cool the gas leaving downstream from the dielectric tube where the discharge occurs.

The performance of the same device (all things being otherwise equal) according to U.S. Pat. No. 5,965,786 without the invention and with the invention (that is to say with a part 2 having only one radial gas inlet along a diameter close to that of tube 4 and a part according to the invention with its tangential gas injections) is considerably improved.

Indeed, according to the invention, a rate of destruction of 90% is obtained at a power of approximately 3000 W, and a rate of destruction of 99% at a power of 3500 W. Without the invention, it is not possible to treat a flow rate of 80/liters/min (slm) with sufficient performance to offer practical value.

By using a device without implementing the invention and with only 60 slm flow rate, more than 5500 W are required to destroy 95% of the same concentration of 5000 ppmv of SF₆. This in comparison with the invention (60 slm and the same mixture) where less than 2500 W are required.

Additional measurements at 80 slm have shown that the result depends very little on the concentration of SF₆ between 1000 and 5000 ppmv.

The pressure loss remains perfectly within the limits prescribed for industrial use, with a certain margin for the case of unintentional fluctuations which could result from some operating conditions.

In addition, a radical change has actually been found in the spatial distribution of the plasma and its stability with time. The plasma remains well centered on the axis and has an apparent radial extension that is smaller than in the case of injection without helical injection of gases. Visualization has been carried out with a camera through a transparent silica tube with lateral incidence. This visualization has shown the absence of instability with decentering and the absence of adhesion of the plasma to the wall of the tube. Axial observations have also been carried out in a ceramic tube which confirm the fixed nature of the plasma at the center of the cross section of the tube.

It has also been found that the quantity of heat radiated by the plasma is less with the invention than without the invention.

It has been possible to carry out destruction experiments under nominal conditions over several hours in a silica tube, without any damage being noted on the wall of the tube, in particular frosting following chemical attack on the surface by corrosive fluorinated compounds. As a comparison, without implementing the invention and under the same conditions, a silica tube is perforated by chemical erosion and/or by local fusion, in a few minutes.

For total flow rates of 50 and 60 slm, the same injection procedure is used (process effluents entering through 4 tangential channels with a diameter approximately half of that of the dielectric tube and compressed air entering through two channels 22, 23 with a diameter approximately half of that of the channels 1, 8, 9 and 10). The destruction rate in relation to the microwave power is substantially better than at 80 slm and the pressure loss falls.

When the total flow is reduced below 50 slm, a stable helical movement can still be maintained in this supply configuration for a flow rate as low as 30 slm. However, a little less stability is noted in the gas flow.

At a low flow rate, it is therefore preferable to use the auxiliary injection channels 22, 23 to provide a supplementary propelling force in order to maintain the helical movement of the gas, while increasing the additional flow of air or nitrogen up to a total flow rate of 50 slm, for example.

Thus, when only one etching chamber is in operation (flow rate of approximately 20 slm), 30 slm of air or nitrogen are added through the auxiliary injection channels when the exhaust from the process equipment is at a flow rate of 20 slm (one).

10 slm of air or nitrogen are added through the auxiliary injection channels when the exhaust from the process equipment is at a flow rate of 40 slm (two etching chambers in operation).

FIG. 5 shows changes to the destruction rate and the pressure loss as a function of net microwave power, in the first case above (20+30 slm). It will be noted that the curves are very similar for the second case (40+10 slm) whatever the concentration of perfluorinated gas, in particular between 1000 and 5000 ppm.

A dynamic injection head with a single stage is shown in FIG. 6, having a chamber 101 for equalizing the pressure of the gas or gas mixture.

The gas to be treated is injected via the channel 100 into the chamber 101 where the gas pressure is equalized. This chamber is delimited as a cylindrical crown 101 surrounding the tube 105 in which the gases to be treated are injected via injections 106 through the body 108 which surrounds the upper part of the tube 105 and the electrode block 104 for igniting the plasma which passes through the lid 102 of the chamber 101 and of the body of the chamber 103. The lower part of the tube 105 is widened out at 107 so as to fit onto the dielectric tube (not shown).

A dynamic injection head with two stages is represented in FIG. 7, on which the same elements as those of FIG. 6 carry the same references. Injections of the gas to be treated are made through the orifices 201 on the upper part, while auxiliary gas injections (nitrogen, argon) are made through the “bottom” orifices 203 communicating with the pressure equalizing chamber 205, supplied through the channel 204.

The dynamic injection head is directly installed vertically on the ceramic tube in which the plasma is established.

The head described in FIGS. 6 and 7 give the gases a circular movement with a downward displacement coaxial to the tube so that the plasma created does not accidentally adhere to the wall and is sufficiently separated from it in order to offer reinforced protection of the tube. The ceramic tube protected in this way (5) has its thermal load reduced by 25 to 35%, which results in an oil temperature that is substantially lower than in the absence of a downward circular movement of the gases.

The cooling system oil does not deteriorate in contact with the hot ceramic wall (the absence of a carbonaceous deposit on the outer wall of the tube (oil side) bears witness to effectiveness of the device and the uniformity of the “skin temperature” of the tube).

It has been possible to reduce the frequency of preventive maintenance of the apparatus.

For effective functioning of the dynamic injection, it is generally necessary to inject at a minimum gas flow rate of approximately 2 to 60 l/m according to the geometric configuration of the head (number of injectors, diameter of the injectors, angle of incidence etc).

In order to remain within a permanent “vortex” regime in the region of the plasma, the total flow rate should be continually adjusted by adding a complementary flow of nitrogen in another neutral gas (from 0 to 50 l/m) (the flow rate is calculated according to the number of chambers to be treated, several chambers being connected to the system in parallel).

In all cases, the sum of the flow rates of the primary pumps to be treated and of the additional nitrogen should be greater than the minimum operational flow rate of the plasma, which in all cases cannot be less than 2 l/m.

The invention described above is not limited to surface wave plasmas but relates to any atmospheric microwave plasma maintained in a cavity, in particular a dielectric tube, whether this be from a resonating cavity or inside a microwave circuit, for example in a hollow rectangular guide.

1-15. (canceled)

16. A method for converting a first gas or gas mixture containing at least some molecules having at least one bond between two atoms constituting said molecules, into a second gas or gas mixture possibly containing liquid and/or solid products derived from this conversion, wherein at least one bond between two atoms of said molecules is ruptured under the action of an electric and/or magnetic field to which said first gas or gas mixture is subjected, characterized in that the stream of gas or gas mixture is injected through the electric and/or magnetic field in a non-linear manner in order to increase the distance traveled by the gas molecules through said field and therefore to increase the effectiveness of the rupture of the bonds of molecules on the gas or gas mixture.

17. The method of claim 16, wherein the first gas or gas mixture is a mixture comprising fluorinated gaseous effluents such as in particular PFC, HFC or similar gases.

18. The method of claim 16, wherein the first gas or gas mixture comprises molecules having a bond between a fluorine atom and another atom, capable of producing molecular fluorine by passage through the electric and/or magnetic field.

19. The method of claim 16, wherein the gas or gas mixture is injected into the field with an amount of tangential movement of the gas or gas mixture greater than the amount of axial movement of said gas or gas mixture.

20. The method of claim 19, wherein the amount of tangential movement is very much greater than the amount of axial movement.

21. The method of claim 16, wherein at least part of the gas or gas mixture is injected with a tangential velocity component into a cavity before being subjected to the action of the electric and/or magnetic field.

22. The method of claim 21, wherein the gas or gas mixture is injected by means of a plurality of injections comprising a tangential component.

23. The method of claim 16, wherein the tangential injections are regularly distributed over the circumference.

24. The method of claim 16, wherein the injections are situated in the same plane.

25. The method of claim 16, wherein the injections are in different planes.

26. The method of claim 16, wherein the injections situated in the same plane are regularly distributed.

27. The method of claim 16, wherein injections of the gas to be treated are made in a first plane and an injection of the propellant gas such as air, nitrogen or oxygen is made in a second plane, preferably parallel to the first.

28. A gas injection apparatus for implementing the method of claim 16, wherein this apparatus comprises at least one first gas injection channel, preferably situated in a plane perpendicular to the axis of said tube of which the upper end is closed.

29. The apparatus of claim 28, wherein it includes at least one second gas injection channel, preferably situated in a plane perpendicular to the axis of the tube.

30. The apparatus of claim 28, wherein it includes a dynamic injection head with two levels also including orifices for injecting an auxiliary gas.
